(19) United States
(12) Patent Application Publication
(10) Pub. No.: US 2005/0132703 A1
(43) Pub. Date: Jun. 23, 2005

(54) Rotating fluid machine

(75) Inventors: Kenji Matsumoto, Wako-shi (JP); Naoki Itoh, Wako-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 10/998,712

(22) Filed: Nov. 30, 2004

(30) Foreign Application Priority Data
Dec. 1, 2003 (JP) 2003-401321

(51) Int. Cl. F16D 39/00

(52) U.S. Cl. 60/487

(57) ABSTRACT

A fixed side valve plate slides in contact with a movable side valve plate provided at a rotor of a rotary valve for supplying and discharging high-temperature high-pressure steam to and from an expansion chamber of an expander via a slide surface. The fixed side valve plate includes an expansion region having a large sliding area to which a circular steam supply passage opens, and an exhaust region having a small sliding area to which an arc-shaped steam discharge passage opens. An unsymmetrical recessed portion formed in a central portion of the slide surface and an arc-shaped notch formed at an outer peripheral portion of the expansion region, make the sliding area of the expansion region and the sliding area of the exhaust region substantially correspond to each other to make the surface pressure uniform, thereby preventing uneven abrasion of the slide surface to suppress leakage of steam.

### CROSS-REFERENCE TO RELATED APPLICATION

The present non-provisional application claims priority under 35 USC 119 to Japanese Patent Application No. 2003-401321 filed on Dec. 1, 2003 the entire contents thereof is hereby incorporated by reference.

### BACKGROUND OF THE INVENTION

1. Field of the Invention

The present invention relates to a rotating fluid machine including a casing, a rotor rotatably supported at the casing, a working section provided at the rotor, and a rotary valve which is provided between the casing and the rotor for controlling an expansion or compression stroke and an exhaust or intake stroke of a working medium with respect to the working section.

2. Description of the Related Art

A rotating fluid machine having a rotary valve including a fixed side valve plate supported at the casing side and a movable side valve plate supported at the rotor side which are in contact with each other on a slide surface is known, for example, as disclosed in Japanese Patent Application Laid Open No. 2002-256805. A circular steam supply passage and an arc-shaped steam discharge passage open to the slide surface of the fixed side valve plate; and seven steam passages, which communicate with seven expansion chambers of the rotor, open to the slide surface of the movable side valve plate equidistantly in the circumferential direction.

Accordingly, a high-temperature high-pressure steam, which is supplied from the steam supply passage of the fixed side valve plate to a predetermined steam passage of the movable side valve plate, expands in the expansion chamber to drive the piston. The resultant low-temperature low-pressure steam, which has finished expansion work, is discharged from the predetermined steam passage of the movable side valve plate to the steam supply/discharge passage of the fixed side valve plate. This operation is performed sequentially for the seven expansion chambers, thereby driving the rotor to rotate.

Of the circular steam supply passage and the arc-shaped steam discharge passage, which open to the slide surface of the fixed side valve plate, the circular steam supply passage has a small opening area, while the arc-shaped steam discharge passage has a large opening area. Therefore, the expansion region of the slide surface of the fixed side valve plate opposed to the steam passage connecting to the expansion chamber in the expansion stroke has a large sliding area since only the circular steam supply passage opens, while the exhaust region of the slide surface of the fixed side valve plate opposed to the steam passage connecting to the expansion chamber in the exhaust stroke has a small sliding area since the arc-shaped steam discharge passage opens. Thus, in the slide surface of the fixed side valve plate, the area of the expansion region and the area of the exhaust region are imbalanced, so that the abrasion of the exhaust region with the smaller sliding area, of the slide surface of the fixed side valve plate and the slide surface of the movable side valve plate, is promoted to impair the flatness of the sliding surface, leading to a fear of leakage of the working medium from the rotary valve.

### SUMMARY OF THE INVENTION

The present invention has been achieved in view of the above circumstances, wherein one object is to prevent uneven abrasion of a slide surface of a rotary valve of a rotating fluid machine and to inhibit leakage of a working medium.

In order to attain the above-described object, according to a first feature of the present invention, there is provided a rotating fluid machine comprising: a casing; a rotor rotatably supported by the casing; a working section provided in the rotor; and a rotary valve provided between the casing and the rotor for controlling an expansion or compression stroke and an exhaust or intake stroke of a working medium with respect to the working section, the rotary valve having a fixed side valve plate supported at the casing side and a movable side valve plate supported at the rotor side which are in contact with each other on a slide surface, supply and discharge passages for the working medium formed in the fixed side valve plate being open to the slide surface, wherein the slide surface of the fixed side valve plate has an expansion or compression region with a small opening area of the supply and discharge passages and an exhaust or intake region with a large opening area of the supply and discharge passages, and wherein a sliding area of the expansion or compression region and a sliding area of the exhaust or intake region are set to be substantially equal.

According to a second feature of the present invention, in addition to the first feature, the rotating fluid machine is an expander having the expansion stroke and the exhaust stroke, and has the intake stroke at an early stage of the expansion stroke.

An axial piston cylinder group A of the embodiment corresponds to the working section of the present invention, an expander E of the embodiment corresponds to the rotating fluid machine of the present invention, and a second steam passage P2 and a fifth steam passage P5 of the embodiment correspond to the supply and discharge passages of the present invention.

With arrangement of the first feature, the slide surface of the fixed side valve plate including the expansion or compression region with the small opening area of the supply and discharge passages as well as the exhaust or intake region with the large opening area of the supply and discharge passage is set so that the sliding area of the expansion or compression region and the sliding area of the exhaust or intake region are substantially equal. Therefore, the uneven abrasion of the slide surface due to the slide area difference between the expansion or compression region and the exhaust or intake region is prevented to suppress leakage of the working medium, thus enhancing the efficiency of the rotating fluid machine.

With arrangement of the second feature, the rotating fluid machine is the expander having the expansion stroke and the exhaust stroke, and has the intake stroke at the early stage of the expansion stroke. Therefore, the sliding area of the expansion region corresponding to the expansion stroke following the intake stroke is decreased to suppress the uneven abrasion of the slide surface effectively.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a longitudinal sectional view of an expander;

FIG. 2 is an enlarged view of the section 2 in FIG. 1;

FIG. 3 is an exploded perspective view of a rotor;

FIG. 4 is an enlarged view of the section 4 in FIG. 1;

FIG. 5 is a view taken along the line 5-5 in FIG. 4;

FIG. 6 is a view taken along the line 6-6 in FIG. 4;

FIG. 7 is a view taken along the line 7-7 in FIG. 4;

FIG. 8 is a view taken along the line 8-8 in FIG. 4; and

FIG. 9 is a perspective view of a coil spring, a packing retainer and a V packing.

### DETAILED DESCRIPTION OF THE PREFERRED EMBODIMENT

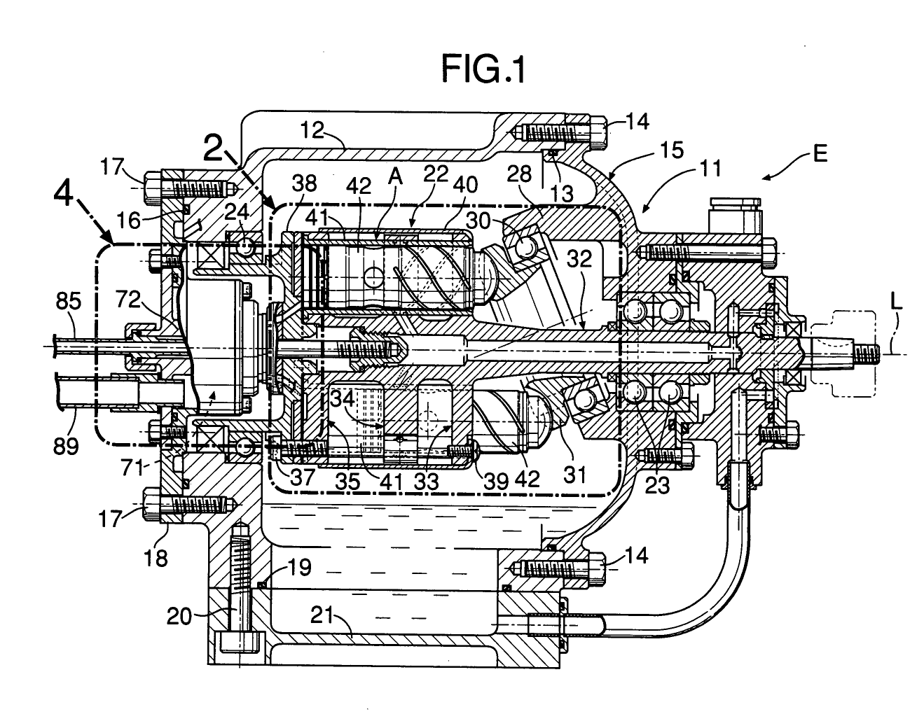

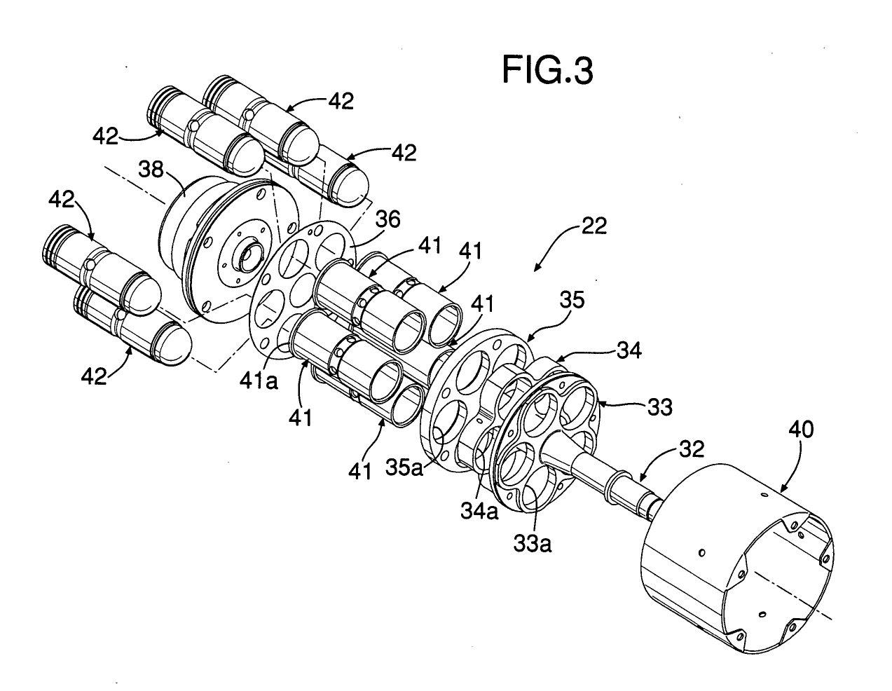

As shown in FIG. 1 to FIG. 3, an expander E of this embodiment is used in, for example, a Rankine cycle system. The expander E converts the thermal energy and the pressure energy of high-temperature high-pressure steam as a working medium into mechanical energy that is outputted. A casing 11 of the expander E is formed from a casing body 12, a front cover 15 joined via a seal 13 to a front opening of the casing body 12 by a plurality of bolts 14, a rear cover 18 joined via a seal 16 to a rear opening of the casing body 12 by a plurality of bolts 17, and an oil pan 21 joined via a seal 19 to a lower opening of the casing body 12 by a plurality of bolts 20.

A rotor 22 is arranged rotatably around an axis L and extends in the fore-and-aft direction through the center of the casing 11 with a front part supported by combined angular bearings 23 provided in the front cover 15, and a rear part thereof supported by a radial bearing 24 provided in the casing body 12. A swash plate holder 28 is formed integrally with a rear face of the front cover 15. A swash plate 31 is rotatably supported by the swash plate holder 28 via an angular bearing 30. The axis of the swash plate 31 is inclined relative to the axis L of the rotor 22, and the angle of inclination is fixed.

The rotor 22 includes an output shaft 32 supported in the front cover 15 by the combined angular bearings 23, three sleeve support flanges 33, 34, and 35 formed integrally with a rear part of the output shaft 32, a rotor head 38 that is joined by a plurality of bolts 37 to the rear sleeve support flange 35 via a metal gasket 36 and is supported in the casing body 12 by the radial bearing 24, and a heat-insulating cover 40 that is fitted over the three sleeve support flanges 33, 34, and 35 from the front and joined to the front sleeve support flange 33 by a plurality of bolts 39.

Sets of five sleeve support holes 33a, 34a, and 35a are formed in the three sleeve support flanges 33, 34, and 35 respectively at intervals of 72° around the axis L. Five cylinder sleeves 41 are fitted into the sleeve support holes 33a, 34a, and 35a from the rear. A flange 41a is formed on the rear end of each of the cylinder sleeves 41, and axial positioning is carried out by abutting this flange 41a against the metal gasket 36 while fitting the flange 41a into a step 35b formed in the sleeve support holes 35a of the rear sleeve support flange 35 (see FIG. 8). A piston 42 is slidably fitted within each of the cylinder sleeves 41, the front end of the piston 42 abutting against a dimple 31a formed on the swash plate 31, and a steam expansion chamber 43 is defined between the rear end of the piston 42 and the rotor head 38.

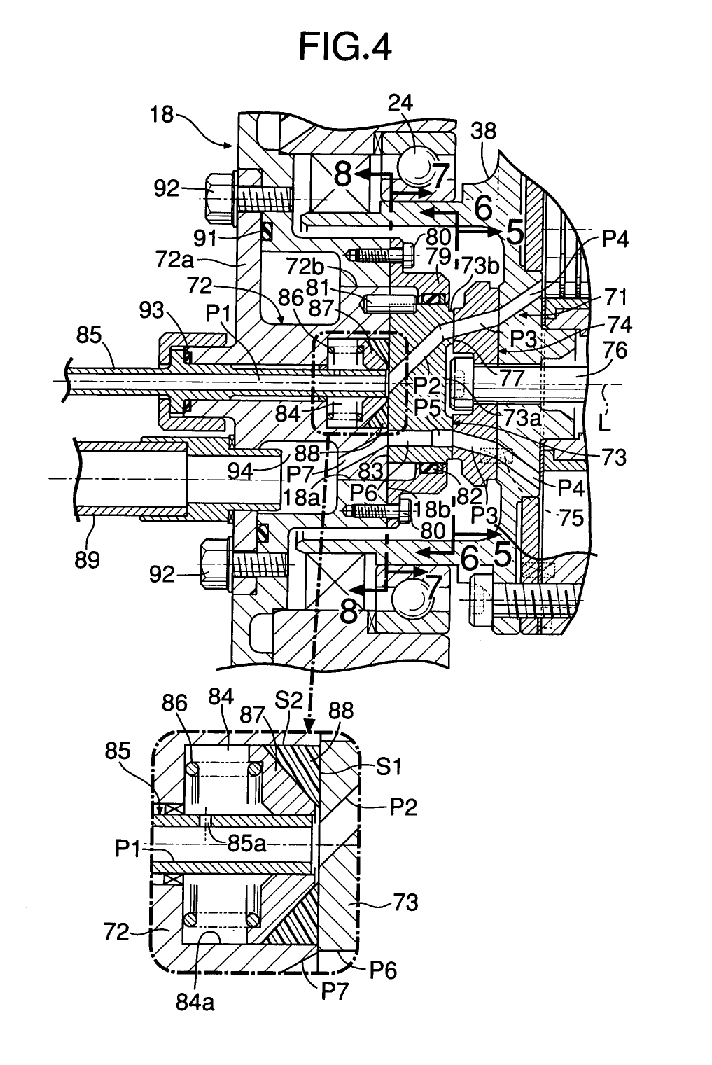

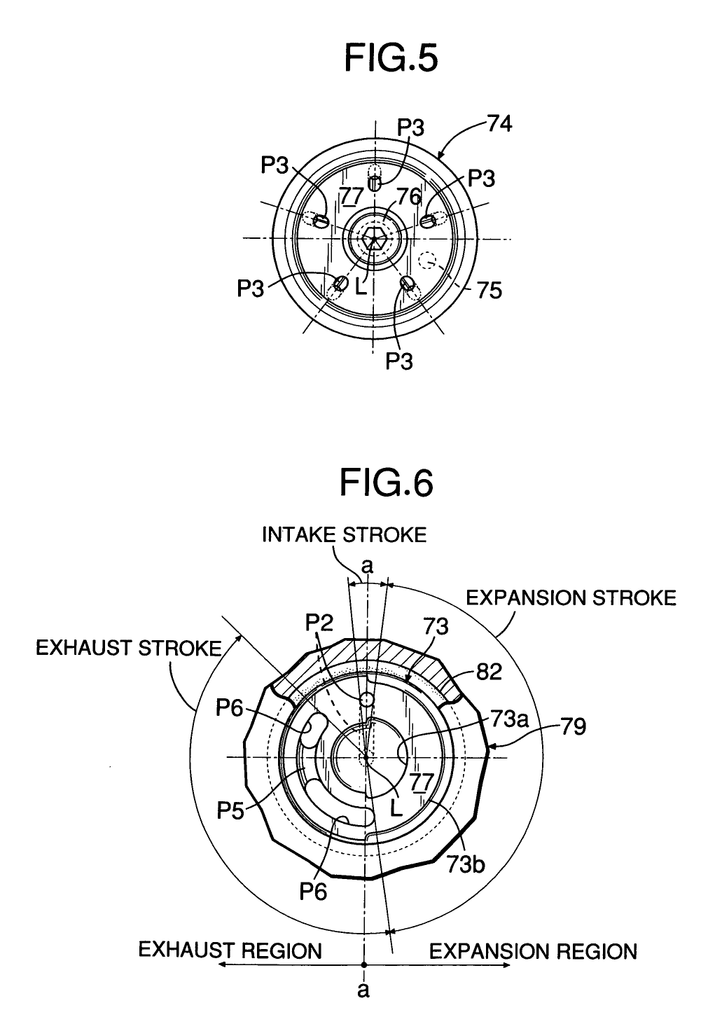

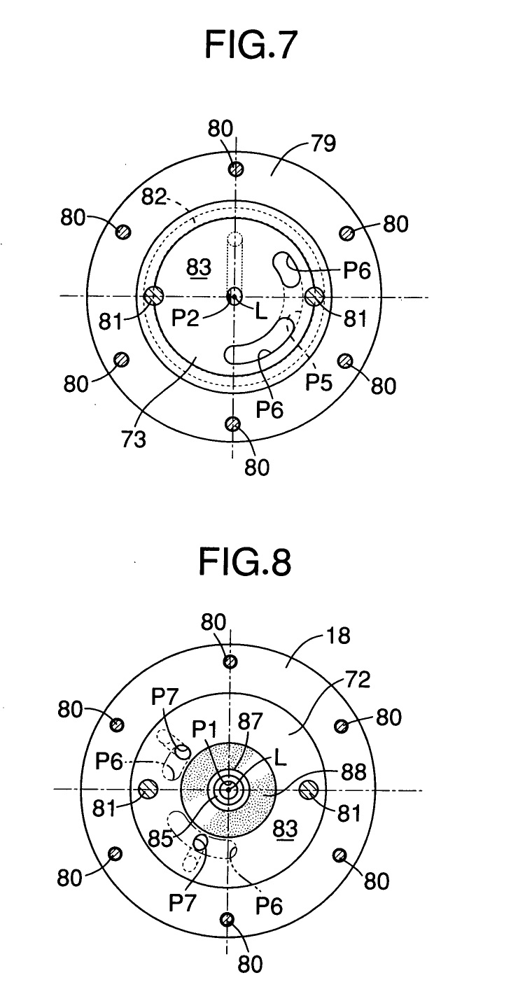

Next, the structure of a rotary valve 71 which supplies and discharges steam to and from five expansion chambers 43 of the rotor 22 will be described with reference to FIG. 4 to FIG. 9.

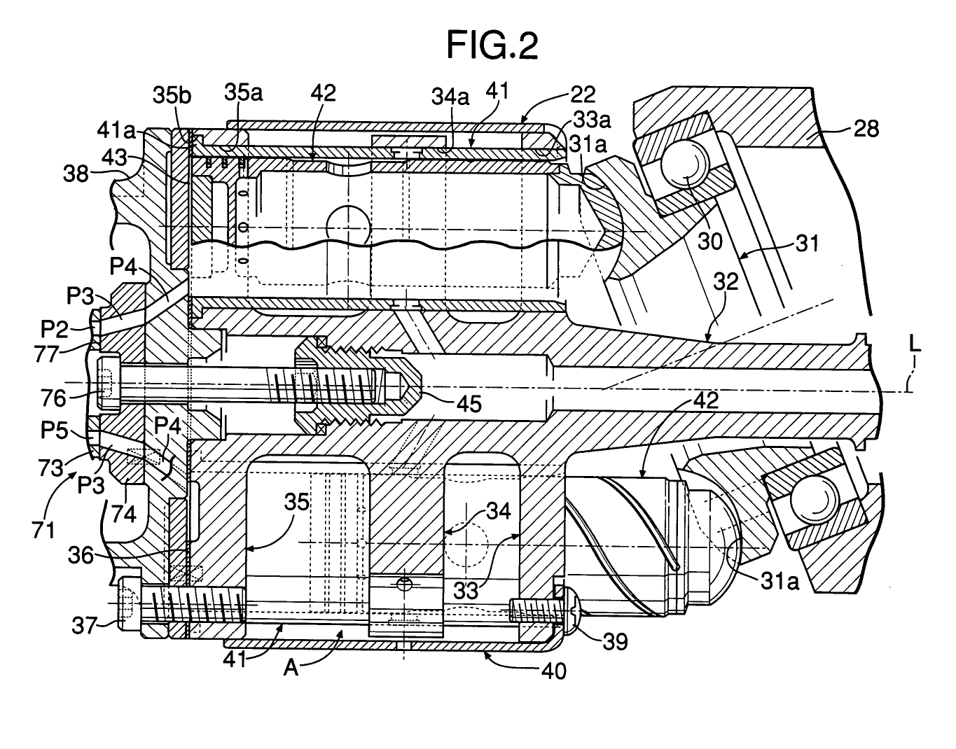

As shown in FIG. 4, the rotary valve 71 disposed along the axis L of the rotor 22 includes a valve body portion 72, a fixed side valve plate 73 made of carbon, and a movable side valve plate 74 made of carbon, TEFLON®, metal or the like. In a state in which the movable side valve plate 74 is positioned by a knock pin 75 in the rotating direction on a rear surface of the rotor 22, the movable side valve plate 74 is fixed by a bolt 76 which is screwed into an oil passage closing member 45 (see FIG. 2). The bolt 76 also has a function of fixing the rotor head 38 to the output shaft 32.

In the valve body part 72, a circular flange 72a, which is integrally formed at a rear portion of the valve body part 72, abuts to a rear surface of the rear cover 18 via a seal member 91, and is fixed by a plurality of bolts 92. In this case, a support portion 72b with a circular section, which is integrally formed at a front portion of the valve body part 72, is fitted in a support hole 18a of the rear cover 18. An annular holder 79 is fixed by a plurality of bolts 80 to a support surface 18b leading to the support hole 18a of the rear cover 18. The fixed side valve plate 73, which is held within the holder 79 via a seal member 82, is prevented from rotating by knock pins 81 and 81 coated with TEFLON®. The fixed side valve plate 73 is positioned in the rotating direction by the knock pins 81 and 81, but is floatingly supported to be slightly movable in the radial direction and the direction of the axis L.

A pressure chamber 84 with a circular section is opened to a mating surface 83 where the valve body part 72 abuts to the fixed side valve plate 73. A steam supply pipe 85, which penetrates through the valve body part 72 via a seal member 93, extends through a center of the pressure chamber 84 to reach the mating surface 83. Inside the pressure chamber 84, a coil spring 86, a packing retainer 87 and a V packing 88 are sequentially disposed on an outer periphery of the steam supply pipe 85.

A small gap is provided between a tip end of the steam supply pipe 85 and the mating surface 83 of the fixed side valve plate 73, so that even if the steam supply pipe 85 thermally expands in the direction of the axis L, the tip end does not interfere with the mating surface 83. One through-hole 85a which is formed in the steam supply pipe 85 communicates with a rear part of the pressure chamber 84. The high-temperature high-pressure steam supplied to the pressure chamber 84 urges the fixed side valve plate 73 toward the movable side valve plate 74 to bring slide surfaces 77 of the valve plates 73 and 74 into close contact with each other, thereby exhibiting a function of improving the sealing performance. A plurality of through-hole 85a may be provided in correspondence to the strength of the steam supply pipe 85 and the required steam supply amount to the pressure chamber 84.

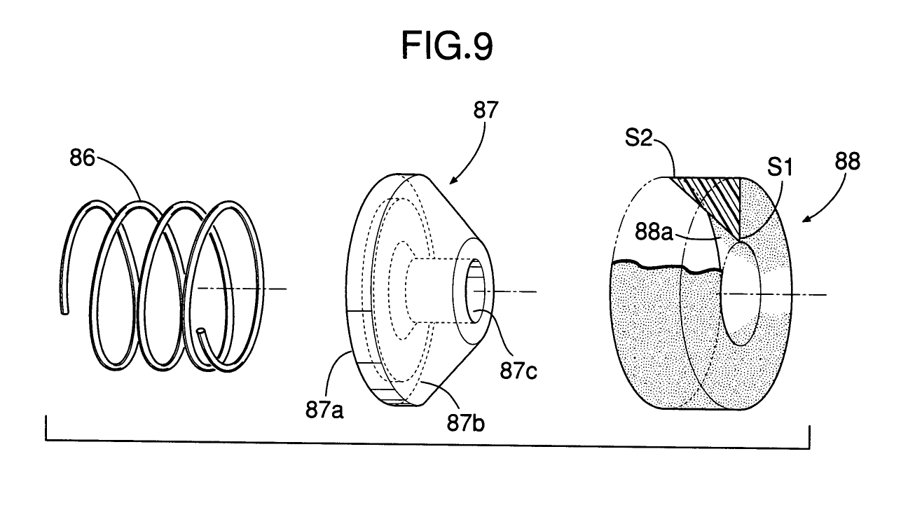

As is obvious from FIG. 4 and FIG. 9, the packing retainer 87, which is urged by the coil spring 86 which are formed of a uniform diameter without tapering, includes a flat surface 87a to which the coil spring 86 abuts, a conical surface 87b which is formed on an opposite side from the flat surface 87a, and a through-hole 87c which is loosely fitted on an outer periphery of the steam supply pipe 85. Formed on the V packing 88 held by the packing retainer 87 are a conical surface 88a which is supported on the conical surface 87b of the packing retainer 87, a first seal lip S1 which seals a gap to the mating surface 83 of the fixed side valve plate 73, and a second seal lip S2 which seals a gap to an inner peripheral surface 84a of the pressure chamber 84.

The V packing 88 has a main object of sealing the gap to the inner peripheral surface 84a of the pressure chamber 84 so that the second seal lip S2 is deformed outwardly in a radial direction by the steam pressure of the pressure chamber 84 to be in close contact with the inner peripheral surface 84a. Accordingly, the second seal lip S2 excellently follows the extension of the inner diameter of the inner peripheral surface 84a of the pressure chamber 84 due to thermal expansion of the valve body section 72, to thereby ensure the sealing performance.

The coil spring 86 functions to provide a preliminary load to press the V packing 88 against the mating surface 83 via the fixed side valve plate 73 before the development of the pressure of the high-temperature high-pressure steam, and to dampen the vibration of the fixed side valve plate 73 in cooperation with the seal member 82 and the pressure of the high-temperature high-pressure steam in the pressure chamber 84. The packing retainer 87 functions to hold the V packing 88 in an appropriate posture inside the pressure chamber 84, and to enhance the durability of the V packing 88 by blocking the heat of the high-temperature high-pressure steam.

The coil spring 86 has a structure in which a spring seat is eliminated in order to secure a large number of winding of the spring in the small space inside the pressure chamber 84. The packing retainer 87 interposed between the coil spring 86 and the V packing 88 is used as a spring seat without causing the coil spring 86 to directly abut to the V packing 88. Therefore, a special spring seat is not needed to be provided in the V packing 88, and the size of the pressure chamber 84 is reduced in the direction of the axis L while securing the maximum length of the coil spring 86.

As is clear from FIG. 4 to FIG. 8, the steam supply pipe 85 is disposed on the axis L of the rotor 22. A steam discharge pipe 89 is disposed to be eccentrically positioned outwardly in the radial direction of the steam supply pipe 85. A first steam passage P1 formed inside the steam supply pipe 85 communicates with the slide surface 77 via a second steam passage P2 formed in the fixed side valve plate 73. Five third-steam-passages P3, which are equidistantly disposed to surround the axis L, penetrate through the movable side valve plate 74. Opposite ends of five fourth-steam-passages P4, which are formed in the rotor 22 to surround the axis L, communicate respectively with the third steam passages P3 and the expansion chamber 43. While a portion at which the second steam passage P2 opens to the slide surface 77 is circular, a portion at which a fifth steam passage PS opens to the slide surface 77 is formed into an arc shape with the axis L as the center.

On the slide surface 77 of the fixed side valve plate 73, the arc-shaped fifth steam passage P5 and two arc-shaped sixth steam passages P6 and P6, which communicate with one another, are each provided in a concave form. The sixth steam passage P6 and P6 communicate with seventh steam passages P7 and P7, which are formed in the valve body section 72, at the mating surface 83. A steam discharge chamber 94 is formed between the casing body 12 and the rear cover 18. The steam discharge chamber 94 communicates with the steam discharge pipe 89, and communicates with the seventh steam passages P7 and P7 which are formed in the valve body 72.

As is obvious from FIG. 6, the circular second steam passage P2 for supplying the high-temperature high-pressure steam, and the arc-shaped fifth steam passage P5 for discharging low-temperature low-pressure steam are opened to the slide surface 77 of the fixed side valve plate 73 of the rotary valve 71. An intake stroke starts at the moment when one of the five third-steam-passages P3 of the movable side valve plate 74 communicates with the circular second steam passage P2. An expansion stroke is performed from the time when the third steam passage P3 is shut off from the communication with the second steam passage P2 until the third steam passage P3 communicates with the arc-shaped fifth steam passage P5. An exhaust stroke is performed while the third steam passage P3 is communicating with the arc-shaped fifth steam passage P5.

The slide surface 77 of the fixed side valve plate 73 is divided into two on the left and the right by the line a-a connecting the starting points of the second steam passage P2 and the fifth steam passage P5. When the right side is defined as an expansion region and the left side as an exhaust region, only a part of the circular second steam passage P2 and a part of the arc-shaped fifth steam passage P5 open in the expansion region on the right side, while most part of the arc-shaped fifth steam passage P5 opens in the exhaust region on the left side. Therefore, the sliding area of the expansion region is larger than the sliding area of the exhaust region in this situation.

Thus, in this embodiment, the radius of a recessed portion 73a formed at the central part of the fixed side valve plate 73 is made large in the expansion region on the right side, and is made small in the exhaust region on the left side; and an arc-shaped notch 73b is formed to extend over 180° along the outer peripheral portion of the expansion region on the right side, whereby the sliding area in the expansion region on the right side and the sliding area in the exhaust region on the left side are set to be substantially equal.

Next, the operation of the expander E of the present embodiment with the above-described construction will be described.

The high-temperature high-pressure steam generated by heating water by a vaporizer passes through the first steam passage P in the steam supply pipe 85, the mating surface 83 and the second steam passage P2 of the fixed side valve plate 73, to reach the slide surface 77 of the movable side valve plate 74. The second steam passage P2 which opens to the slide surface 77 instantly communicates, at a predetermined timing, with the five third-steam-passages P3 formed in the movable side valve plate 74 which rotates integrally with the rotor 22, so that the high-temperature high-pressure steam passes from the third steam passage P3 through the fourth steam passage P4 formed in the rotor 22, to be supplied to the expansion chamber 43 in the cylinder sleeve 41.

Even after the communication between the second steam passage P2 and the third steam passage P3 is shut off with the rotation of the rotor 22, the high-temperature high-pressure steam expands in the expansion chamber 43, whereby the piston 42 fitted in the cylinder sleeve 41 is pushed forward from the top dead center to the bottom dead center, and the front end of the piston 42 presses the dimple 31a of the swash plate 31. As a result, a rotation torque is given to the rotor 22 due to the reaction force which the piston 42 receives from the swash plate 31. Thus, every time the rotor 22 makes one-fifth of a turn, the high-temperature high-pressure steam is supplied into a new adjacent expansion chamber 43, thereby continuously driving the rotor 22 to rotate.

While the piston 42 having reached the bottom dead center with the rotation of the rotor 22 retreating to the top dead center by being pressed by the swash plate 31, the low-temperature low-pressure steam pushed out of the expansion chamber 43 is supplied to a condenser via the fourth steam passage P4 of the rotor 22, the third steam passage P3 of the movable side valve plate 74, the slide surface 77, the fifth steam passage P5 and the sixth steam passages P6 and P6 of the fixed side valve plate 73, the mating surface 83, the seventh steam passages P7 and P7 of the valve body section 72, the steam discharge chamber 94 and the steam discharge pipe 89.

The rotary valve 71 supplies and discharges steam to and from an axial piston cylinder group A via the flat slide surface 77 between the fixed side valve plate 73 and the movable side valve plate 74, thereby effectively preventing the leakage of the steam. This is because the flat slide surface 77 is easily machined with high precision and the control of the clearance is easier as compared with a cylindrical slide surface. In addition, when the pressure of the high-temperature high-pressure steam supplied to the expander E becomes high, the high-temperature high-pressure steam becomes likely to leak from the slide surface 77 of the fixed side valve plate 73 and the movable side valve plate 74, but the pressing load, which the pressure chamber 84 generates in accordance with the increase in the pressure, increases to enhance the surface pressure of the slide surface 77, thus exhibiting a sealing performance corresponding to the pressure of the high-temperature high-pressure steam.

Uniform surface pressure acts on the slide surface 77 of the fixed side valve plate 73 and the movable side valve plate 74, but when the sliding area of the expansion region and the sliding area of the exhaust region in FIG. 6 are imbalanced, the region with the smaller sliding area is abraded earlier by the increase in the surface pressure to impair the flatness of the slide surface 77, leading to a fear that the steam leaks from the slide surface 77 to reduce the efficiency of the expander E. However, as described above, the unsymmetrical recessed portion 73a formed in the central portion of the slide surface 77 and the arc-shaped notch 73b formed along the outer peripheral portion of the expansion region, make the sliding area in the expansion region and the sliding area in the exhaust region substantially correspond to each other to make the surface pressure uniform, thereby preventing the uneven abrasion of the slide surface 77 to suppress the leakage of the steam.

Especially in the expander E, the second steam passage P2 opens to the starting points of the expansion region, from which no opening exists substantially over 180° in the slide surface 77. Therefore, the imbalance in the sliding area between the expansion region and the exhaust region where the fifth steam passage P5 opens to the most part of the exhaust region is significant. However, according to this embodiment, the imbalance is compensated to effectively prevent the uneven abrasion of the slide surface 77.

The embodiment of the present invention has been described, but various changes in design can be made without departing from the subject matter of the invention.

For example, the expander E of the embodiment includes the axial piston cylinder group A as the working section, but the structure of the working section is not limited thereto.

The rotating fluid machine of the present invention is not limited to the expander E, and can be applied to a compressor. When the present invention is applied to a compressor, the expansion stroke and the expansion region of the expander E become the compression stroke and the compression region, respectively, and the exhaust stroke and the exhaust region become the intake stroke and the intake region, respectively.

1. A rotating fluid machine comprising:
a casing;
a rotor rotatably supported by the casing;
a working section provided in the rotor; and
a rotary valve provided between the casing and the rotor for controlling an expansion or compression stroke and an exhaust or intake stroke of a working medium with respect to the working section,
the rotary valve having a fixed side valve plate supported at the casing side and a movable side valve plate supported at the rotor side which are in contact with each other on a slide surface,
supply and discharge passages for the working medium formed in the fixed side valve plate being open to the slide surface,
wherein the slide surface of the fixed side valve plate has an expansion or compression region with a small opening area of the supply and discharge passages and an exhaust or intake region with a large opening area of the supply and discharge passages, and
wherein a sliding area of the expansion or compression region and a sliding area of the exhaust or intake region are set to be substantially equal.

2. The rotating fluid machine according to claim 1, wherein the rotating fluid machine is an expander having the expansion stroke and the exhaust stroke, and has the intake stroke at an early stage of the expansion stroke.
